(19) United States
(12) Patent Application Publication
(10) Pub. No.: US 2015/0111184 A1
(43) Pub. Date: Apr. 23, 2015

(54) OPTIMAL PATH OF MOTION FOR TRAINING SIMULATOR

(71) Applicant: Harnischfeger Technologies, Inc., Wilmington, DE (US)

(72) Inventors: Michael J. Rikkola, New Berlin, WI (US); James Benedict, II, Racine, WI (US)

(21) Appl. No.: 14/447,299

(22) Filed: Jul. 30, 2014

Related U.S. Application Data
(60) Provisional application No. 61/894,585, filed on Oct. 23, 2013.

(51) Int. Cl. G09B 9/05

(52) U.S. Cl. CPC G09B 9/05
USPC 434/219

(57) ABSTRACT

Systems, methods, and non-transitory computer-readable medium encoded with executable instructions for training an operator. One method includes generating a simulated mining environment and a simulated shovel including a simulated dipper, receiving a first series of operating commands from a first operator for moving the simulated dipper, and calculating an optimal digging path based on the first series of operating commands. The method also includes generating a graphical representation of at least a portion of the optimal digging path and displaying the graphical representation to a second operator, wherein the graphical representation provides a guide to the second operator for moving the simulated dipper along the optimal digging path. The method further includes receiving a second series of operating commands from the second operator for moving the simulated dipper, and automatically modifying the graphical representation based on the optimal digging path and the second series of operating commands.

### RELATED APPLICATIONS

This application claims priority to U.S. Provisional Application No. 61/894,585 filed Oct. 23, 2013, the entire content of which is incorporated by reference herein.

### BACKGROUND

Embodiments of the invention relate to methods and systems for training operators of industrial equipment, such as shovels and wheel loaders in a simulated environment.

### SUMMARY

Industrial equipment, such as electric rope or power shovels, draglines, wheel loaders, etc., is used to execute digging operations to remove material from, for example, a bank of a mine. For example, an operator controls a shovel or a wheel loader during a dig operation to load a dipper with materials. The operator deposits the materials in the dipper into a haul truck. After unloading the materials, the dig cycle continues and the operator swings the dipper back to the bank to perform additional digging.

Given the high cost of the industrial equipment and the value of efficient and cost-effective operation of the equipment, properly training an operator is important. However, based on these same parameters, providing real-world or on-site training for operators is difficult. Therefore, computer-based training simulators can be used to train operators. Computer-based simulators generate a simulated training environment that provides simulated industrial equipment, such as a simulated shovel and/or a simulated wheel loader, and a simulated working environment.

Within the simulated working environment (and a real-world environment), there may be multiple ways to properly operate particular equipment, such as multiple paths of motion of a dipper on a shovel during a dig cycle. However, some ways to operate the equipment may be more efficient for material remove or equipment operation (e.g., fuel or energy expenditure) or may result in less wear on the equipment, etc. than other ways. These ways can be considered an “optimal” way to operate the equipment (i.e., an “optimal path of motion” or “optimal path”). Optimal paths of motion, however, may be difficult to train within a simulated working environment, as some of the aspects that make a particular path of motion optimal relate to real-world aspects of a working environment. Accordingly, learning the optimal path of motion may require real-world experience that the training simulator cannot provide.

Accordingly, embodiments of the invention provide methods and systems for training an operator by establishing an optimal path of motion for at least one component of simulated industrial equipment provided within a training simulator (e.g., an optimal path of motion of a simulated dipper or a simulated bucket during a dig cycle). To establish the optimal path of motion, an operator experienced in operating the equipment (i.e., in the real world) that is simulated in the training simulator operates the training simulator one or more times. Data representing the operator's path of motion of the at least one component performed within the training simulator is stored. For example, data representing a complete dig cycle performed by the experienced operator (e.g., motion and speed) can be stored. The stored data is used to generate an optimal path of motion for the at least one component. The optimal path is also used to generate at least one indicator that can be displayed within the training simulator as a guide for performing an optimal path of motion. In some embodiments, the at least one indicator includes a representation of the at least one component of the simulated industrial equipment (e.g., a dipper). The representation can move along the optimal path, and an operator can attempt to duplicate or follow the representation by aligning the at least one component with the representation.

In particular, one embodiment of the invention provides a system for training an operator. The system includes a computing device including a processing unit and computer-readable medium. The computer-readable medium stores a training simulator application. The training simulator application, when executed by the processing unit, is configured to generate a simulated working environment and simulated industrial equipment, receive a first series of operating commands from a first operator for moving at least a portion of the simulated industrial equipment, and calculate an optimal path based on the first series of operating commands. The training simulator application is also configured to generate an indicator representing at least a portion of the optimal path and display the indicator to a second operator within the simulated working environment. The indicator provides a guide to the second operator for moving the simulated industrial equipment along the optimal path. The training simulator application is also configured to receive a second series of operating commands from the second operator for moving the simulated industrial equipment, and automatically modify the indicator based on the second series of operating commands.

Another embodiment of the invention provides a method of training an operator. The method includes generating a simulated mining environment and a simulated shovel including a simulated dipper, receiving a first series of operating commands from a first operator for moving the simulated dipper, and calculating, with a processing unit, an optimal digging path based on the first series of operating commands. The method also includes generating, with the processing unit, a graphical representation of at least a portion of the optimal digging path and displaying the graphical representation to a second operator within the simulated mining environment, wherein the graphical representation provides a guide to the second operator for moving the simulated dipper along the optimal digging path. The method further includes receiving a second series of operating commands from the second operator for moving the simulated dipper and automatically, with the processing unit, modifying the graphical representation based on the optimal digging path and the second series of operating commands.

Yet another embodiment of the invention provides Non-transitory computer-readable medium encoded with a plurality of processor-executable instructions for training an operator. The instructions include generating a simulated mining environment and a simulated shovel including a simulated dipper, receiving a first series of operating commands from a first operator for moving the simulated dipper, and calculating an optimal digging path based on the first series of operating commands. The instructions also include generating a graphical representation of at least a portion of the optimal digging path and displaying the graphical representation to a second operator within the simulated mining environment, wherein the graphical representation provides a guide to the second operator for moving the simulated dipper along the optimal digging path. The instructions further include receiving a second series of operating commands from the second operator for moving the simulated dipper and automatically modifying the graphical representation based on the optimal digging path and the second series of operating commands.

Other aspects of the invention will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a system for training an operator according to an embodiment of the invention.

FIGS. 2-4 are screen shots illustrating a simulated training environment generated by the system of FIG. 1.

FIG. 5 is a flow chart illustrating a method of providing an optimal path help function with the system of FIG. 1.

FIGS. 6-13 are screen shots illustrating an optimal path help function generated by the system of FIG. 1.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, the methods, operations, and sequences described herein can be performed in various orders. Therefore, unless otherwise indicated herein, no required order is to be implied from the order in which elements, steps, or limitations are presented in the detailed description or claims of the present application. Also unless otherwise indicated herein, the method and process steps described herein can be combined into fewer steps or separated into additional steps.

In addition, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “controllers” described in the specification can include one or more processors, one or more computer-readable medium modules, one or more input/output interfaces, and various connections (e.g., a system bus) connecting the components.

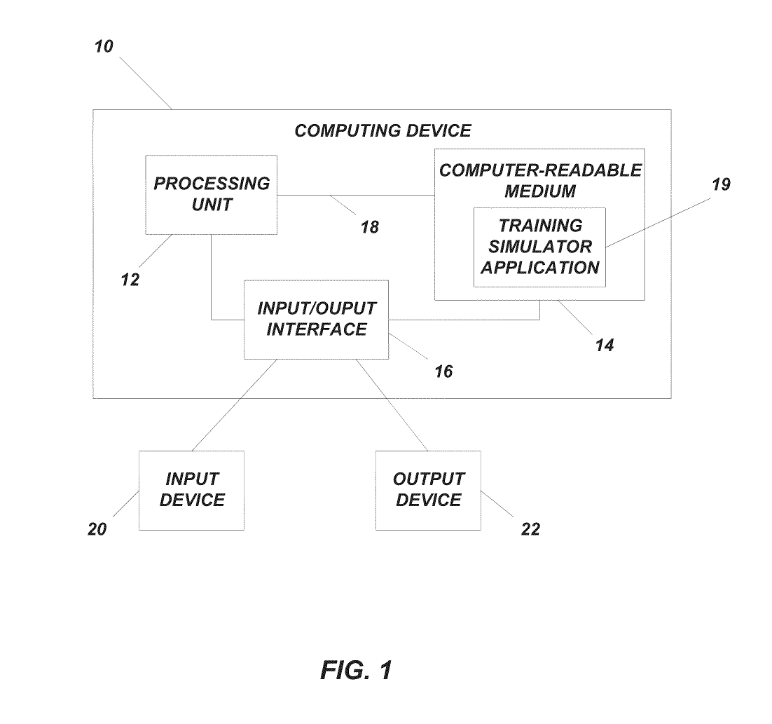

FIG. 1 illustrates a system for training an operator according to an embodiment of the invention. The system includes a computing device 10 including combinations of hardware and software operable to, among other things, generate a simulated training environment that provides a simulated shovel and a simulated working environment. As illustrated in FIG. 1, the computing device 10 includes, among other things, a processing unit 12 (e.g., a microprocessor, a microcontroller, or another suitable programmable device), non-transitory computer-readable medium 14, and an input/output interface 16. The processing unit 12, the medium 14, and the input/output interface 16 are connected by one or more control and/or data buses (e.g., a common bus 18). The control and/or data buses are shown generally in FIG. 1 for illustrative purposes.

It should be understood that in other constructions, the computing device 10 includes additional, fewer, or different components. It should also be understood that the computing device 10 can include a general purpose computer that executes various modules or applications stored in the medium 14. In other embodiments, the computing device 10 includes a server that executes various modules or applications, and other devices connect to the server (e.g., over at least one network) to provide input to and access output from the server. In still other embodiments, the computing device 10 is a dedicated device providing simulated training and is included as part of a console that includes mock shovel interiors mounted on a platform to simulate an actual shovel.

The computer-readable medium 14 stores program instructions and data and, in particular, stores a training simulator application 19. The processing unit 12 is configured to retrieve the application 19 from the medium 14 and execute the application 19 to generate a simulated training environment that includes simulated industrial equipment, such as a shovel and/or a wheel loader, and a simulated working environment as described below. The input/output interface 16 transmits data from the computing device 10 to external systems, networks, and/or devices and receives data from external systems, networks, and/or devices. The input/output interface 16 can also store data received from external sources to the medium 14 and/or provide the data to the processing unit 12.

As illustrated in FIG. 1, the input/output interface 16 communicates with at least one input device 20. The input device 20 can include a device controlled by an operator to issue operating commands for the simulated industrial equipment (e.g., propel shovel, swing dipper, hoist dipper, crowd dipper, dump materials from dipper, etc.) and/or select operating parameters for the simulated working environment (e.g., camera view, shovel type, mine type, weather, time of day, etc.). For example, the input device 20 can include a keyboard, a joystick, a mouse, a touchscreen, a trackball, tactile buttons, a pedal, etc. In some embodiments, the input device 20 includes similar control devices as included in actual (i.e., real world) industrial equipment. The input device 20 can be connected to the computing device 10 via one or more wired connections (e.g., a universal serial bus (“USB”) cable) and/or wireless connections. In some embodiments, when the computing device 10 acts as a server that hosts the training simulator, the input device 20 includes a computing device that accesses the server over at least one network (e.g., a local area network (“LAN”) or the Internet).

The input/output interface 16 also communicates with at least one output device 22. The output device 22 can include at least one monitor or screen (e.g., a liquid crystal display (“LCD”) monitor) that displays the generated simulated training environment to the operator. In some embodiments, the output device 22 includes multiple screens that provide the operator with a wide view of the training environment. The output device 22 can also include a projector that projects the generated training environment on at least one surface. The output device 22 can also include a device that provides audible or tactile feedback to the operator. For example, the output device 22 can include one or more speakers that provide audible warnings or realistic worksite sounds to the operator. The output device 22 can also include a vibration device that provides tactile feedback to the operator (e.g., indicating a collision or impact). In some embodiments, the output device 22 also includes a movable chair that moves (e.g., using hydraulic mechanisms) to provide the operator with a realistic training experience. As described above for the input device, the output device 22 can be connected to the computing device 10 via one or more wired connections and/or wireless connections.

It should be understood that in some embodiments a device can be connected to the input/output interface 16 that operates as both an input device 20 and an output device 22. For example, a touchscreen can be used that displays a simulated training environment to an operator and receives commands or selections from the operator. In addition, when the computing device 10 operates as a server that hosts the training simulator application 19, devices accessing the server operate as both an input device 20 and an output device 22.

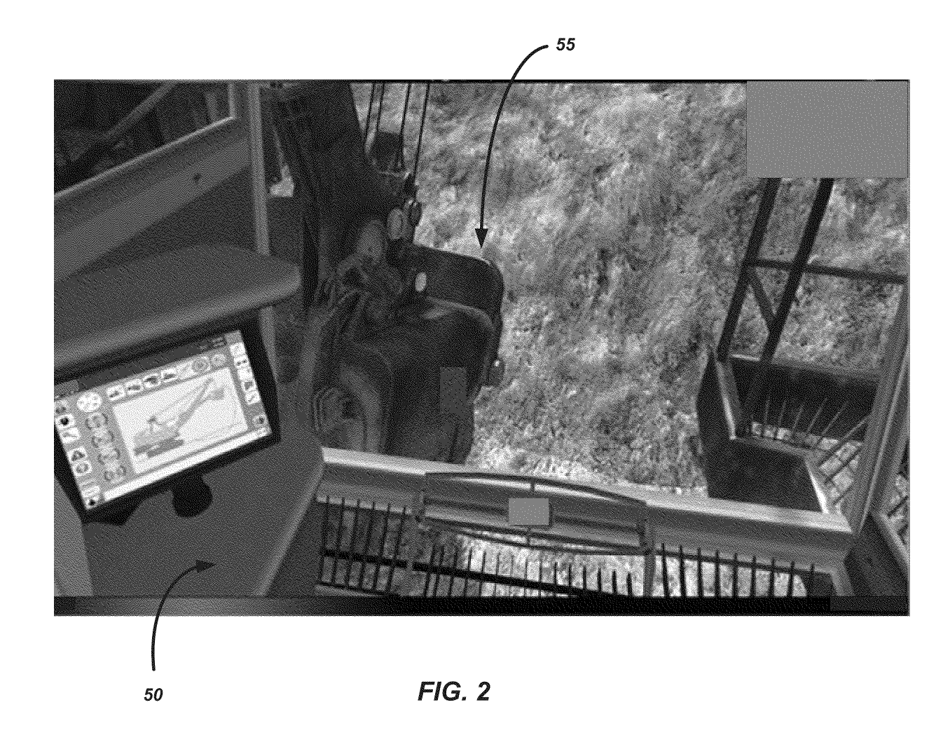

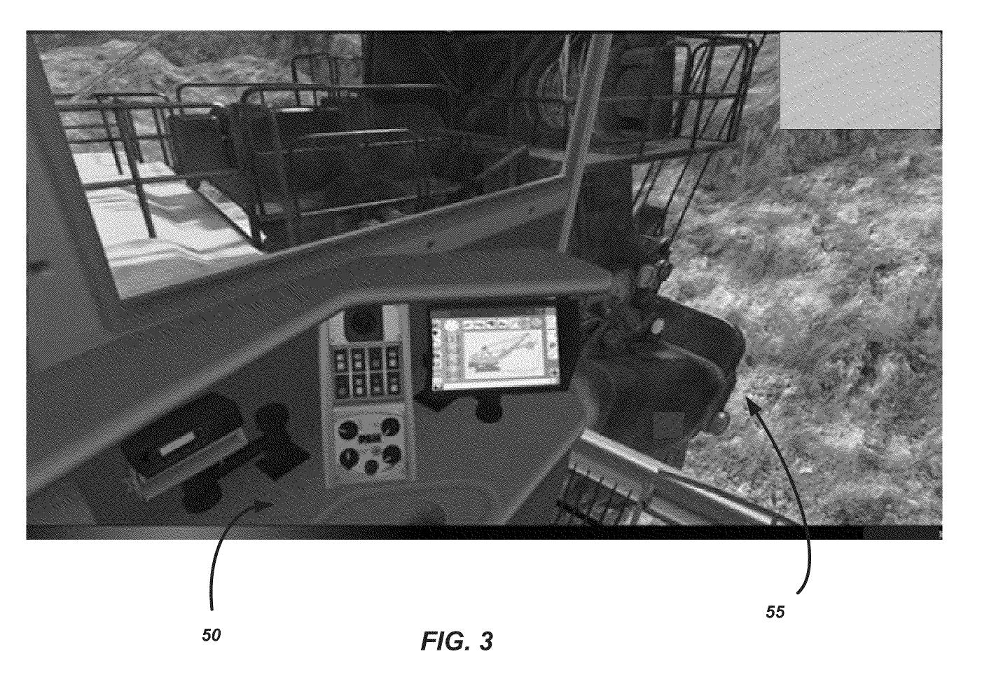

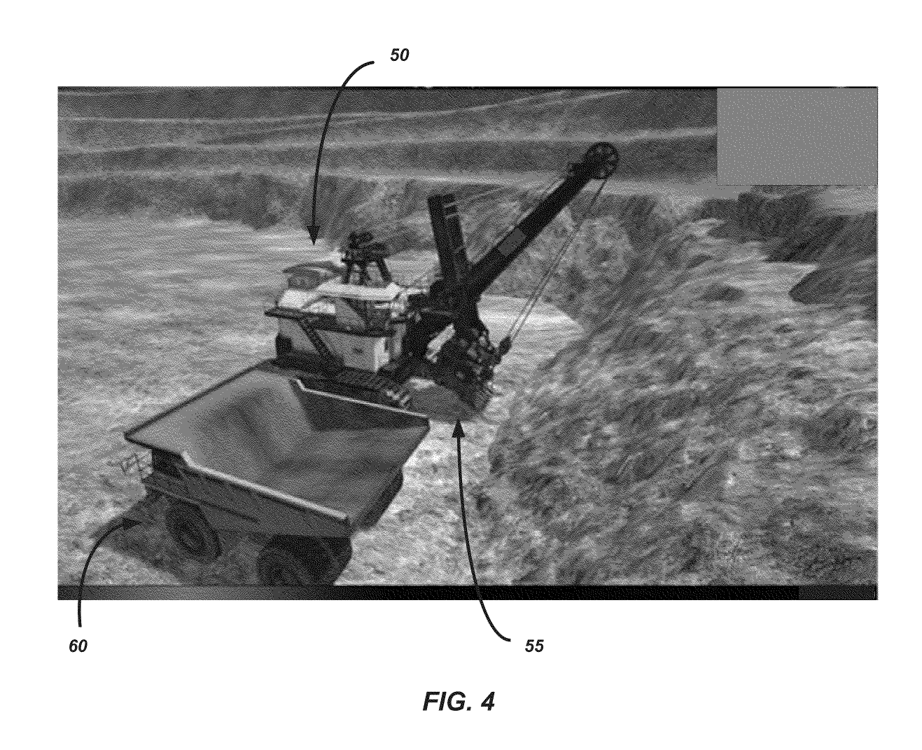

As mentioned above, the computing device 10 executes the training simulator application 19 to generate a simulated training environment. FIGS. 2-4 are screen shots illustrating a simulated training environment generated by the application 19 according to embodiments of the invention. As illustrated in FIGS. 2-4, the training environment can include a simulated shovel 50, which includes a simulated dipper 55. The simulated shovel 50 is displayed within a simulated working environment (e.g., a simulated surface mine), which can include other vehicles and objects, such as a simulated haul truck 60. As illustrated in FIGS. 2-4, the application 19 can display the simulated training environment from multiple camera views or perspectives.

The application 19 includes instructions and data for providing various help functions. The help functions provide various indicators (e.g., visual, audible, tactile, etc.) within the simulated training environment to aid the operator in operating the shovel 50. One help function includes an optimal path help function. In particular, as described above in the summary section, although the training simulator application 19 may be able to train an operator to properly operate a particular piece of equipment, there may be multiple ways to properly operate particular equipment, such as multiple paths of motion of a dipper or a bucket during a dig cycle. However, some ways to operate the equipment may be more efficient for material removal or equipment operation or may result in less wear on the equipment, etc. and these ways can be considered an “optimal” way to operate the equipment (i.e., an “optimal path of motion”).

To train an operator to operate a simulated equipment “optimally,” the application 19 can be configured to calculate an optimal path of motion for at least one component of the simulated equipment. For example, the application 19 can be configured to automatically calculate an optimal path of motion (e.g., a shortest path of motion) for the simulated dipper and/or the simulated bucket during a dig cycle. The application 19 can also take various factors into consideration when calculating the optimal path, such as characteristics of the material being mined, weather conditions, mining environment conditions, etc. After calculating the optimal path of motion, the application 19 can display one or more indicators within the simulated working environment based on the generated optimal path to help an operator duplicate the optimal path within the simulated working environment. The indicators are described in more detail below.

In some situations, however, the application 19 may not be capable of calculating an optimal path based on all of the factors facing an operator in a real-world working environment. For example, an experienced operator may understand that particular maneuvers of the equipment (i.e., in the real-world) are difficult to manually perform. Therefore, although certain maneuvers or paths may be “optimal” based on factors considered by the application 19, these “optimal” maneuvers may not be practical within real-world situations based on operator limits or other factors that are difficult to quantify and apply within a software application.

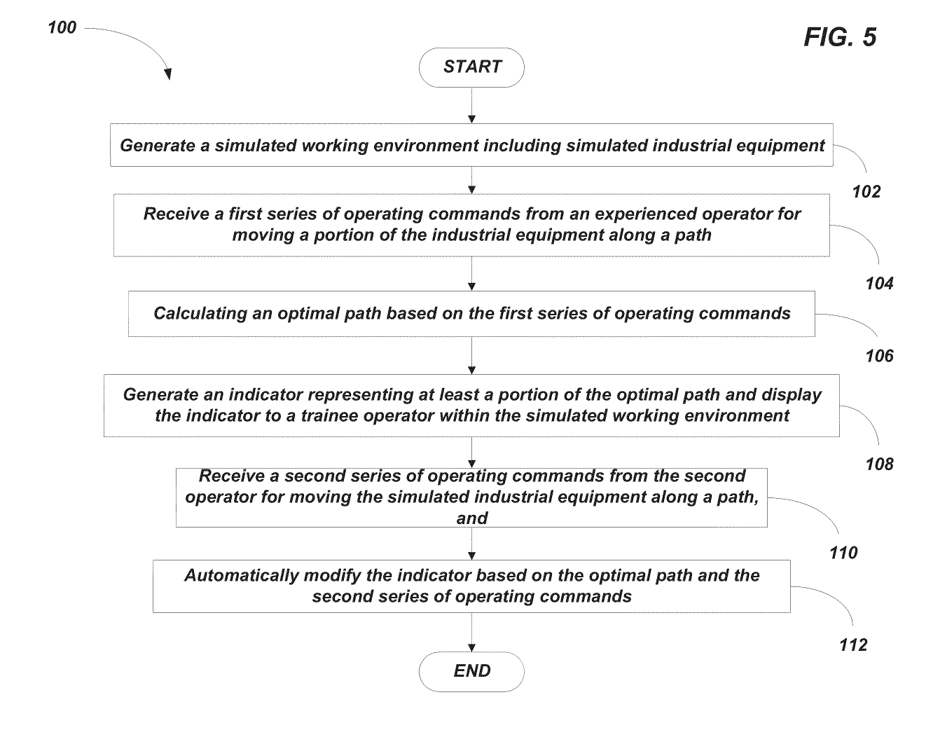

Therefore, in some embodiments, in addition to or as an alternative to automatically calculating an optimal path of motion, the application 19 is configured to generate an optimal path based on an operator's prior use of the application 19 to operate the simulated industrial equipment. For example, FIG. 5 illustrates a method 100 performed by the application 19 (when executed by the processing unit 12) to provide optimal path help functionality. As illustrated in FIG. 5, the method 100 includes generating a simulated working (e.g., mining) environment and simulated industrial equipment (e.g., the simulated shovel 50 including the simulated dipper 55) (at block 102) and allowing an experienced operator to establish an optimal path of motion for the equipment. For example, an operator that is experienced (i.e., in the real world) with the simulated equipment can execute the application 19 and operate the simulated equipment one or more times to move at least a portion of the simulated equipment along a path. The application 19 receives a series of operating commands (e.g., direction and speed) of at least one component of the simulated equipment as controlled by the experienced operation and stores the series of operating commands (e.g., on the memory module 14 and/or on a separate memory module) (at block 104). For example, when the operator controls a simulated shovel 50, the stored data can represent direction and speed of the simulated dipper 55 through a complete dig cycle. In some embodiments, if the experienced operator uses the application 19 to operate the simulated industrial equipment more than one time (e.g., multiple dig cycles performed during one or more multiple uses of the application 19), data representing each operation (e.g., each dig cycle) can be separately stored and/or data representing a composite operation (e.g., average speed and motion of all dig cycles) can be stored. Also, in some embodiments, multiple experienced operators can execute the application 19 and operate the simulated environment and separate and/or composite data can be stored for the multiple operators. Similarly, if the application 19 provides multiple simulated working environments (e.g., environments with different materials, different mining environments or mine configuration, different weather or time of day conditions, etc.), at least one experienced operator can execute the application 19 and operate the simulated industrial equipment within each simulated working environment. Accordingly, the optimal path generated based on the stored data (described below) can be tailored for each simulated working environment provided through the application 19.

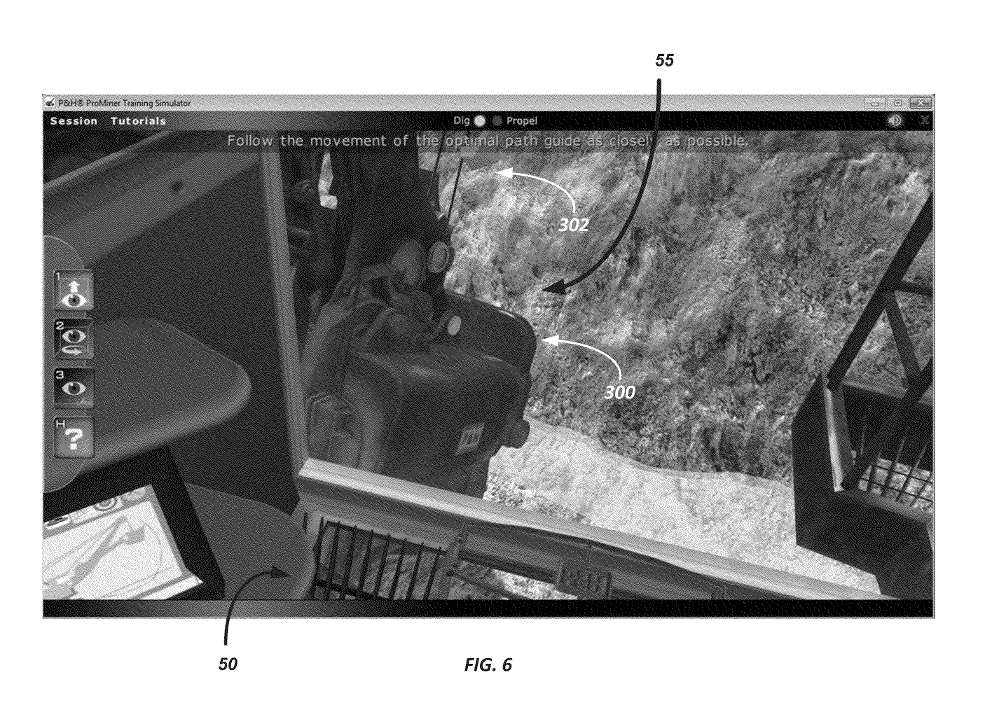

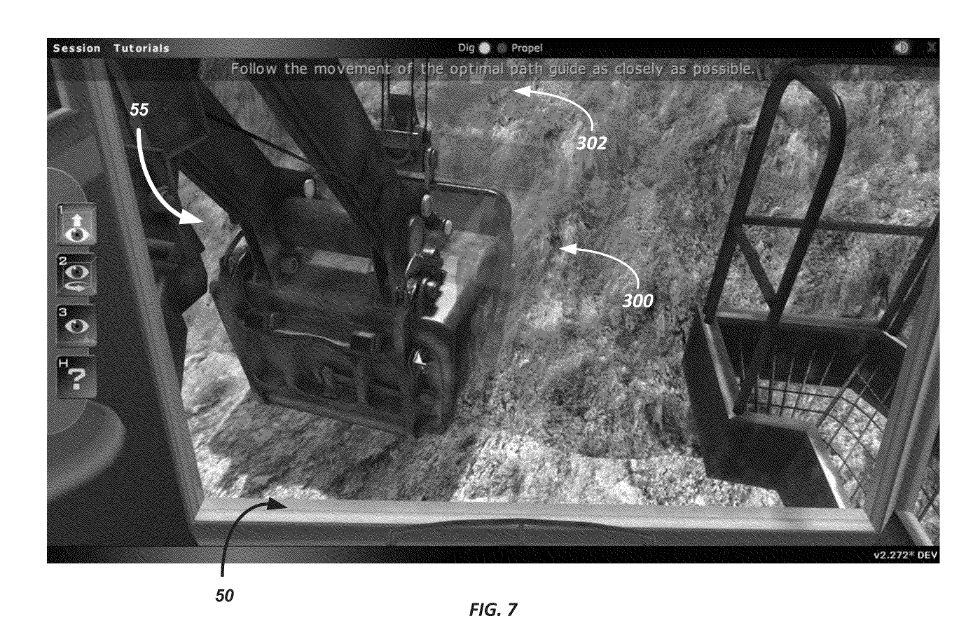

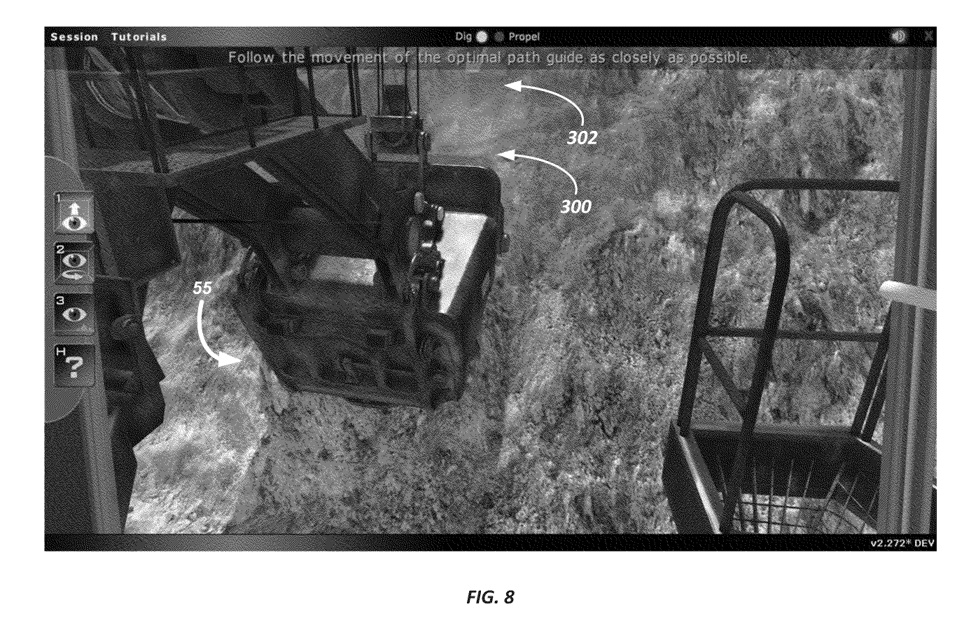

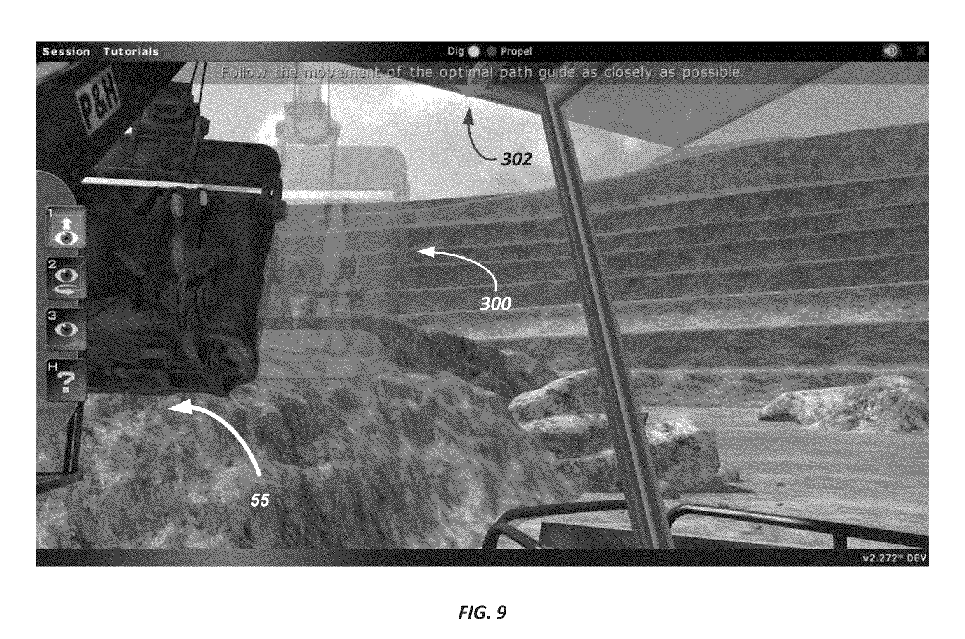

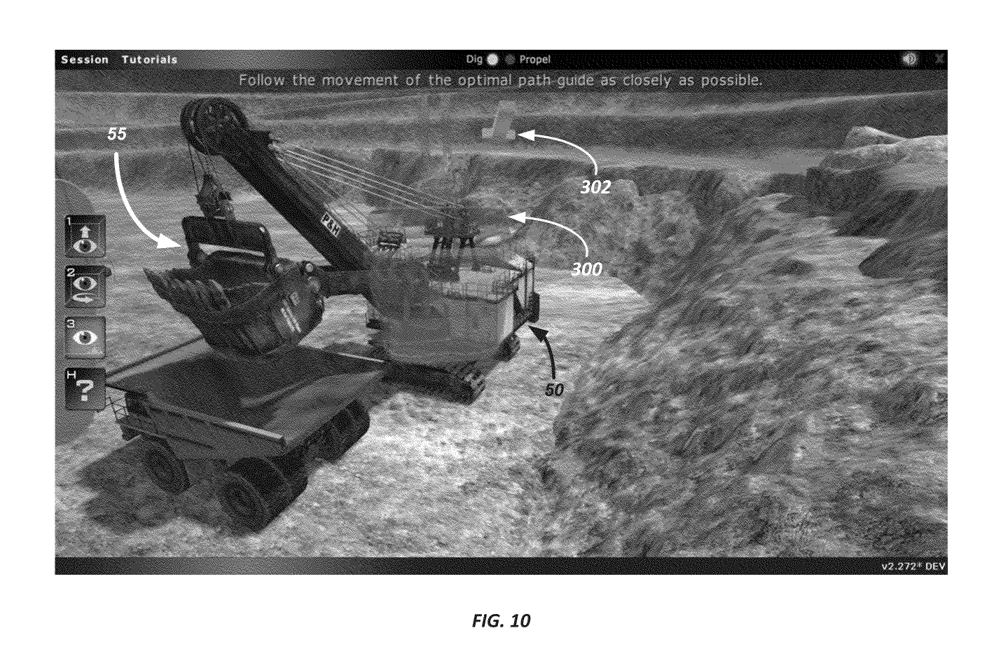

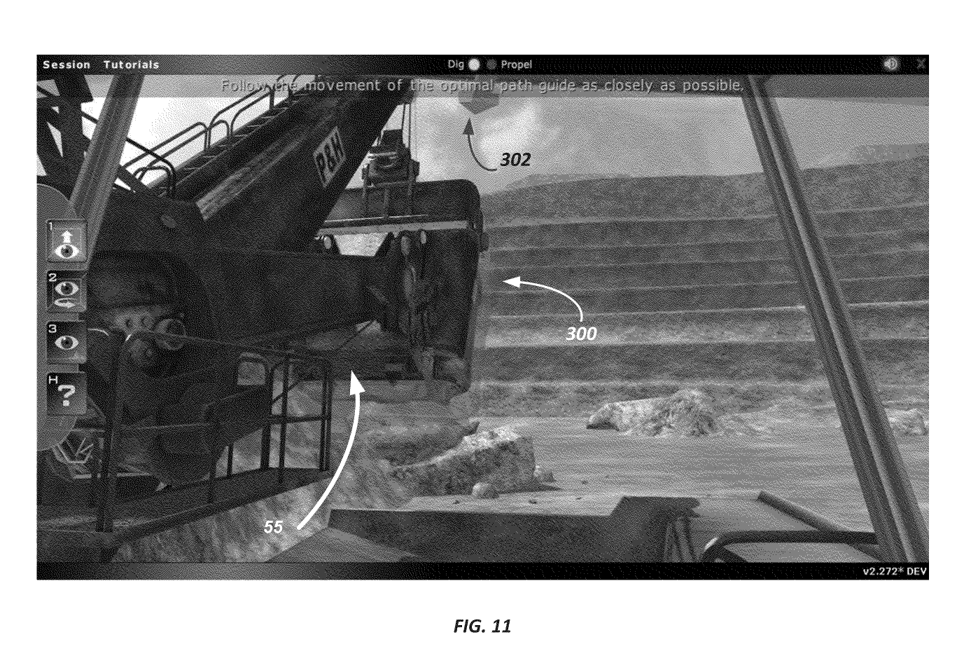

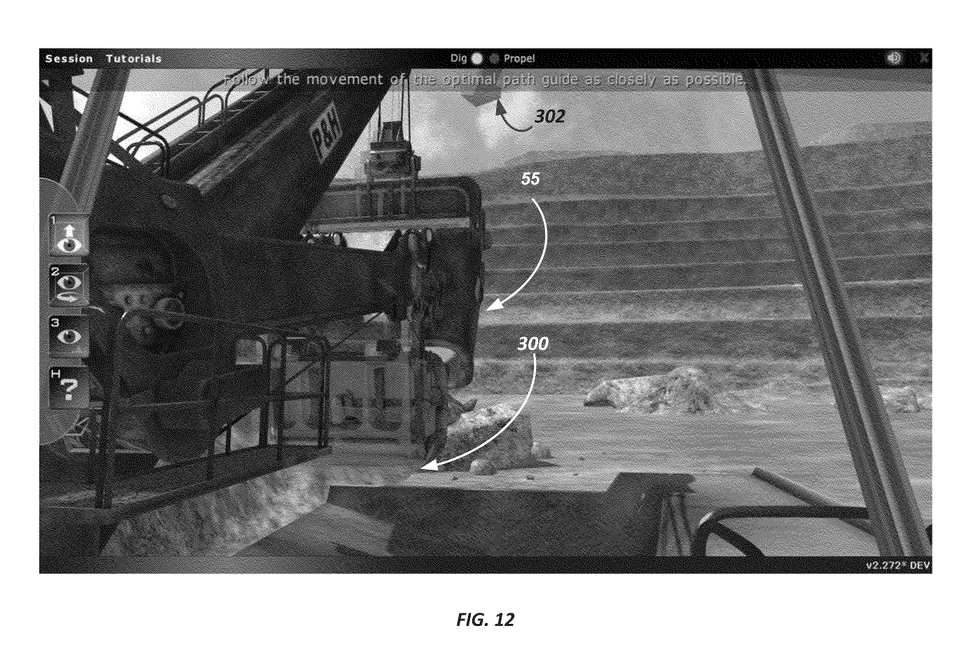

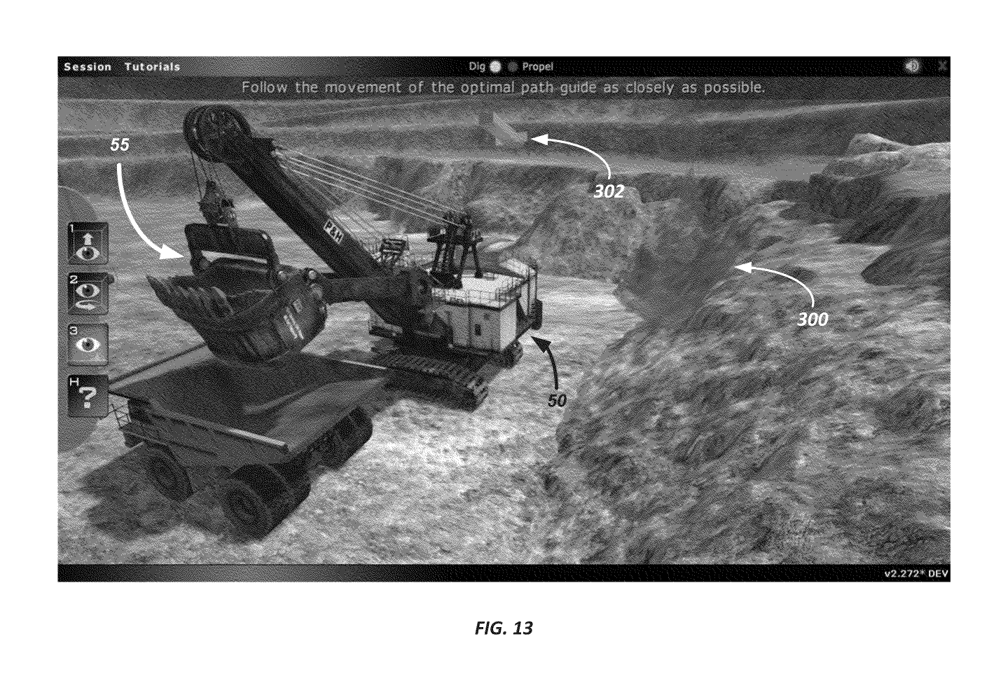

The application 19 uses the one or more stored series of operating parameters to calculate an optimal path for at least one component of the simulated industrial equipment for performing a particular function (e.g., an optimal digging path of a simulated dipper 55 during a complete dig cycle) (at block 106). The application 19 also uses the calculated optimal path to generate one or more indicators and displays the indicator to a different operator (i.e., a trainee operation) within the simulated working environment to aid the operator in performing the optimal path (at block 108). For example, FIGS. 6-13 are screen shots provided by the application 19 that include at least one indicator for training the operator to perform an optimal path of motion. As illustrated in FIGS. 6-13, the indicator provides a guide to the trainee operator for moving at least a portion of the simulated industrial equipment along the optimal path. In some embodiments, as illustrated in FIG. 6-13, the indicator includes an at-least-partially-transparent graphical representation 300 of the at least one component of the simulated industrial equipment (e.g., a semi-transparent graphical representation of the simulated dipper 55). The graphical representation 300 can be overlaid on the simulated component of the industrial equipment (e.g., the simulated dipper 55). Alternatively or in addition, the indicator can include one or more direction indicators 302 (e.g., text, arrows, etc.) that inform the trainee what direction to move to align the component with the optimal path (see, e.g., FIG. 13).

After displaying the indicator, the application 19 receives a series of operating commands from the trainee for the simulated industrial equipment (at block 110) and modifies the displayed indicator based on the received operating commands (at block 112). For example, when the indicator is a graphical representation 300 as illustrated in FIGS. 6-13, the application 19 moves the representation 300 from a starting position to a succeeding position corresponding to the trainee's movement of the simulated industrial equipment. For example, during a dig cycle, a trainee operator can use to the representation 300 to see how the trainee's movement of the simulated equipment aligns with an optimal digging path. Therefore, the trainee operating the simulated industrial equipment within the simulated working environment can attempt to duplicate or follow the optimal path by aligning the at least one component with the representation during the dig cycle. Similarly, if the indicator includes a direction indicator, the application 19 can change the indicator to instruct the trainee operator of the next direction of motion the trainee needs to perform to follow an optimal path. For example, if the trainee has moved the simulated dipper too far left as compared to the optimal digging path, the application 19 can set a direction indicator to a right arrow that informs the trainee that he or she should move the dipper to the right to keep the motion of the dipper aligned with an optimal digging path.

In addition or alternatively, the application 19 can be configured to modify the indicator based on the trainee's operating commands by modifying at least one aspect (e.g., color, size, animation, shape, etc.) of the indicator. For example, the application 10 can set a color of the graphical representation 300 and/or the direction indicators 302 based on an amount of deviation of the trainee's movement of the component from the optimal path of motion (based on direction of movement and/or speed). As an example, if the current position of the simulated industrial equipment (as controlled by the trainee) deviates from the optimal path by less than a predetermined threshold, the application 19 can set the color of the indicator to a first color (e.g., green). Alternatively, if the current position of the simulated industrial equipment (as controlled by the trainee) deviates from the optimal path by more than a predetermined threshold, the application 19 can set the color of the indicator to a second, different color (e.g., red). Similarly, the application 19 can be configured to change the size, shape, or animation (e.g., flashing, pattern, movement, etc.) of the indicator to illustrate an amount of deviation between the trainee's path of motion of the simulated industrial equipment and an optimal path of motion for the simulated equipment. It should also be understood that the indicator can be used to show an optimal position of at least a portion of the simulated industrial equipment and/or an optimal speed for moving at least a portion of the simulated industrial equipment. For example, if the trainee is moving the simulated industrial equipment too quickly or too slowly, the application 19 can be configured to modify the indicator accordingly to inform the trainee of the deviation.

The application 19 can also be configured to generate other visual, audible, and/or tactile alerts if the trainee is not operating the component as specified by the optimal path (e.g., if the trainee is not properly duplicating the optimal path in motion and/or speed). Also, in some embodiments, the application 19 is configured to provide statistics or scores to the trainee based on the trainee performance within the simulated environments. These statistics or scores can take the trainee's duplication of the optimal path into consideration. For example, the application 19 can generate a statistic or score representing a percentage of time that the trainee aligned the movement of the simulated equipment with the optimal path.

Thus, embodiments of the invention provide help functions within a simulated training environment for shovels, wheel loaders, and other industrial equipment. In particular, embodiments of the invention provide systems and methods for generating a simulated training environment including a simulated shovel having a simulated dipper or a simulated wheel loader having a simulated bucket, and displaying at least one indicator in the simulated training associated with an optimal path for at least a portion of the simulated equipment. The indicator is modified based on a comparison between a trainee's motion of the simulated equipment and the optimal path. Scores and/or statistics can also be generated that track how well a trainee tracks an optimal path. These scores and statistics can be displayed to the trainee and/or provided to a training manager.

Various features of the invention are set forth in the following claims.

What is claimed is:

1. A system for training an operator, the system comprising:
a computing device including a processing unit and computer-readable medium, the computer-readable medium storing a training simulator application;
wherein the training simulator application, when executed by the processing unit, is configured to
generate a simulated working environment and simulated industrial equipment,
receive a first series of operating commands from a first operator for moving at least a portion of the simulated industrial equipment,
calculate an optimal path based on the first series of operating commands,
generate an indicator representing at least a portion of the optimal path,
display the indicator to a second operator within the simulated working environment, wherein the indicator provides a guide to the second operator for moving the simulated industrial equipment along the optimal path,
receive a second series of operating commands from the second operator for moving the simulated industrial equipment, and
automatically modify the indicator based on the second series of operating commands.

2. The system of claim 1, wherein the training simulator application, when executed by the processing unit, is further configured to receive a third series of operating commands from a third operator for moving the simulated industrial equipment and wherein the training simulator application, when executed by the processing unit, is configured to calculate the optimal path based on the first series of operating commands and the third series of operating commands.

3. The system of claim 1, wherein the training simulator application, when executed by the processing unit, is configured to calculate the optimal path based on at least one characteristic of the simulated working environment.

4. The system of claim 3, wherein the at least one characteristic includes at least one selected from the group comprising a material being handled by the simulated industrial equipment and a weather condition of the simulated working environment.

5. The system of claim 1, wherein the simulated industrial equipment includes a simulated shovel having a simulated dipper.

6. The system of claim 5, wherein the indicator includes a graphical representation of at least the simulated dipper.

7. The system of claim 6, wherein the graphical representation is at least partially transparent.

8. The system of claim 6, wherein the training simulator application, when executed by the processing unit, is configured to automatically modify the graphical representation to move the graphical representation within the simulated working environment to illustrate a succeeding position of the simulated dipper along the optimal path.

9. The system of claim 1, wherein the training simulator application, when executed by the processing unit, is configured to automatically modify the indicator to change at least one aspect of the indicator based on a comparison between the optimal path and the second series of operating commands, the at least one aspect selected from the group comprising a color, size, animation, and shape of the indicator.

10. The system of claim 1, wherein the training simulator application, when executed by the processing unit, is configured to determine an amount of deviation between the optimal path and the second series of operating commands and automatically modify the indicator by setting the indicator to a first color when the amount of deviation is less than a predetermined threshold and setting the indicator to a second color when the amount of deviation is greater than the predetermined threshold.

11. The system of claim 1, wherein the indicator includes a direction indicator informing the second operator of a direction to move the simulated industrial equipment to follow the optimal path.

12. The system of claim 1, wherein the training simulator application, when executed by the processing unit, is further configured to generate at least one score for the second operator representing an amount of deviation between the optimal path and the second series of operating commands.

13. The system of claim 12, wherein the at least one score includes a percentage of time that the second series of operating commands aligned the portion of the simulated industrial equipment with the optimal path.

14. A method of training an operator, the method comprising:
generating a simulated mining environment and a simulated shovel including a simulated dipper,
receiving a first series of operating commands from a first operator for moving the simulated dipper,
calculating, with a processing unit, an optimal digging path based on the first series of operating commands,
generating, with the processing unit, a graphical representation of at least a portion of the optimal digging path,
displaying the graphical representation to a second operator within the simulated mining environment, wherein the graphical representation provides a guide to the second operator for moving the simulated dipper along the optimal digging path,
receiving a second series of operating commands from the second operator for moving the simulated dipper, and
automatically, with the processing unit, modifying the graphical representation based on the optimal digging path and the second series of operating commands.

15. The method of claim 14, wherein displaying the graphical representation to the second operator within the simulated mining environment includes displaying the graphical representation at least partially transparent overlaid on the simulated dipper.

16. The method of claim 14, wherein automatically modifying the graphical representation includes moving the graphical representation to illustrate a succeeding position of the simulated dipper along the optimal digging path.

17. The method of claim 14, wherein automatically modifying the graphical representation includes changing at least one aspect of the graphical representation based on a comparison between the optimal digging path and the second series of operating commands, the at least one aspect selected from the group comprising a color, size, animation, and shape of the graphical representation.

18. The method of claim 14, further comprising determining an amount of deviation between the optimal digging path and the second series of operating commands and wherein automatically modifying the graphical representation includes setting the graphical representation to a first color when the amount of deviation is less than a predetermined threshold and setting the graphical representation to a second color when the amount of deviation is greater than the predetermined threshold.

19. The method of claim 14, further comprising determining a percentage of time that the second series of operating commands aligned the simulated dipper with the optimal digging path and displaying the percentage of time.

20. Non-transitory computer-readable medium encoded with a plurality of processor-executable instructions for training an operator, the instructions comprising:
generating a simulated mining environment and a simulated shovel including a simulated dipper,
receiving a first series of operating commands from a first operator for moving the simulated dipper,
calculating an optimal digging path based on the first series of operating commands,
generating a graphical representation of at least a portion of the optimal digging path,
displaying the graphical representation to a second operator within the simulated mining environment, wherein the graphical representation provides a guide to the second operator for moving the simulated dipper along the optimal digging path,
receiving a second series of operating commands from the second operator for moving the simulated dipper, and
automatically modifying the graphical representation based on the optimal digging path and the second series of operating commands.
